(19) United States
(12) Patent Application Publication
(10) Pub. No.: US 2017/0203986 A1
(43) Pub. Date: Jul. 20, 2017

(54) WATER PURIFICATION SYSTEM

(71) Applicant: Titan Water Technologies, Inc., Lakeland, FL (US)

(72) Inventor: Keith Ervin, Hartland, WI (US)

(73) Assignee: Titan Water Technologies, Inc., Lakeland, FL (US)

(21) Appl. No.: 15/406,234

(22) Filed: Jan. 13, 2017

Related U.S. Application Data
(60) Provisional application No. 62/279,246, filed on Jan. 15, 2016.
(60) Provisional application No. 62/409,096, filed on Oct. 17, 2016.

(51) Int. Cl. C02F 9/00; A23L 2/72; A23L 2/50; B01D 15/36; B01D 29/05

(52) U.S. Cl. CPC C02F 9/00; B01D 15/361; B01D 29/05; A23L 2/50; A23L 2/72; C02F 2201/3222; C02F 2201/3227; C02F 2201/326; C02F 1/008

(57) ABSTRACT

Systems for water treatment include a preprocessing stage, an ultraviolet treatment stage, and a filtering stage. The preprocessing stage includes first and second chambers including first and second filter media. The first and second chambers include perforated plates. The first chamber and second chamber are vertically arranged in a filter tower. The ultraviolet treatment stage receives water in a plurality of reactor tanks. Each reactor tank of the plurality includes an inlet, an outlet, crystal sleeve disposed centrally to the interior of the reactor tank, and a UVC light source contained within the crystal sleeve. A controller operates the ultraviolet treatment stage to sequentially fill each reactor tank and sequentially drain each reactor tank and operates a respective UVC light source to emit UVC wavelength radiation within a respective reactor tank while water is in the respective reactor tank.

### CROSS-REFERENCE TO RELATED APPLICATION

The present application claims priority of U.S. Provisional Patent Application No. 62/279,246, filed on Jan. 15, 2015, and also claims priority of U.S. Provisional Patent Application No. 62/409,096, filed on Oct. 17, 2016, the contents of which are hereby incorporated herein by reference in their entireties.

### BACKGROUND

The present disclosure is related to the field of fluid processing and purification. More specifically, the present disclosure is related to the purification of water using UVC light.

Water may be contaminated with numerous substances considered harmful to human or other life. Microorganisms for example from wastewater, can spread disease among humans. Pharmaceuticals or hormones can harm biological processes. Minerals and chemicals with harmful cumulative effects can naturally occur or may be present in water distribution systems.

Many industrial or resource extraction operations produce contaminated water. These operations may contaminate water with heavy metals, volatile organic compounds (VOCS), polychlorinated biphenyls (BCBₛ), pharmaceuticals, pesticides, radionuclides, and harmful microorganisms. These and other contaminants must be removed before the water is discharged or it risks contaminating the environment or freshwater resources.

Being a well known source of harmful microorganisms, water is often treated prior to human consumption. Often drinking water is treated with harsh chemicals in order to eliminate harmful microorganisms that can cause health problems in humans and/or pets. There is growing public concern and caution regarding impact on human health from ingesting the chemicals used to treat water. There are similar concerns regarding the impact of the use of these chemicals on the quality of our natural environment.

Therefore, it is desirable for an alternative manner in which to purify water without the use of chemical additives.

### BRIEF DISCLOSURE

An exemplary embodiment of a water treatment system includes a preprocessing stage. The preprocessing stage includes a first chamber being defined by at least one vertically oriented sidewall and a bottom defined by a perforated plate. A first filter media is contained within the first chamber by the at least one vertically oriented sidewall and the perforated plate of the first chamber. A second chamber is defined by at least one vertically oriented sidewall and a bottom defined by a perforated plate. A second filter media is contained within the second chamber by the at least one vertically oriented sidewall and the perforated plate of the second chamber. A first funnel is configured to receive water from the first chamber and direct the water to an outlet. The first chamber, second chamber, and first funnel are vertically arranged in a filter tower wherein the water travels through the filter tower by gravity feed sequentially through second chamber, first chamber, and the first funnel. The water treatment system further includes an ultraviolet treatment stage that receives water from the first funnel and includes a plurality of reactor tanks. Each reactor tank of the plurality includes a valve-controlled inlet and a valve-controlled outlet. Each reactor tank of the plurality further includes a crystal sleeve disposed centrally to the interior of the reactor tank. A UVC light source comprises a plurality of UVC wavelengths emitting light emitting diodes (LEDs) and is contained within the crystal sleeve. A controller is operable connected to each of the valve-controlled inlets, valve-controlled outlets, and UVC light sources. The controller operates the ultraviolet treatment stage to sequentially fill each reactor tank and sequentially drain each reactor tank and operates a respective UVC light source to emit UVC wavelength radiation within a respective reactor tank while water is in the respective reactor tank. The water treatment system includes a filtering stage that receives water from the ultraviolet treatment stage and includes a filtering chamber which includes a third filter media.

An exemplary embodiment of an ultraviolet water treatment system includes a water inlet that receives a flow of water. A first reactor tank includes an inlet with a first inlet valve and an outlet with a first outlet valve. The first reactor tank includes a crystal sleeve disposed through the center of the first reactor tank. A first UVC light source is located within the crystal sleeve. The first UVC light source includes a plurality of UVC wavelength emitting light emitting diodes (LEDs). A controller is communicatively connected to the first inlet valve and the first outlet valve. The controller operate the first inlet valve and the firs outlet valve to selectively fill and drain the first reactor tank from the flow of water at the water inlet. The controller is communicatively connected to the first UVC light source. The controller selectively operates the first UVC light source to emit UVC wavelength radiation when water is inside the first reactor tank.

An exemplary embodiment of a water filtration system includes a first chamber extending in a vertical direction and defined by at least one sidewall and a bottom defied by a perforated plate. A first filter media is contained within the first chamber by the at least one vertically oriented sidewall and the perforated plate of the first chamber. A first funnel is configured to receive water from the first chamber and direct the water to an outlet. The first funnel includes a screen located across the outlet. A first funnel filter media is contained within the funnel and retained within the funnel by the screen located across the outlet.

### BRIEF DESCRIPTION OF THE DRAWINGS

FIGS. 1A and 1B are a system diagram of an exemplary embodiment of a water purification system.

FIG. 2 is a system diagram of an exemplary embodiment of a water purification system.

FIG. 3 depicts an exemplary embodiment of a filter tower.

FIGS. 4A and 4B depict exemplary embodiments of a perforated plate.

FIG. 5 depicts an exemplary embodiment of a reactor tank.

FIG. 6 is a cross-sectional view of a reactor tank of FIG. 5.

FIG. 7 depicts an exemplary embodiment of an ultraviolet light source.

FIG. 8 is a cross-sectional view of the ultraviolet light source taken along line 8-8 of FIG. 7.

FIGS. 9A and 9B depict an additional exemplary embodiment of a water purification system.

### DETAILED DISCLOSURE

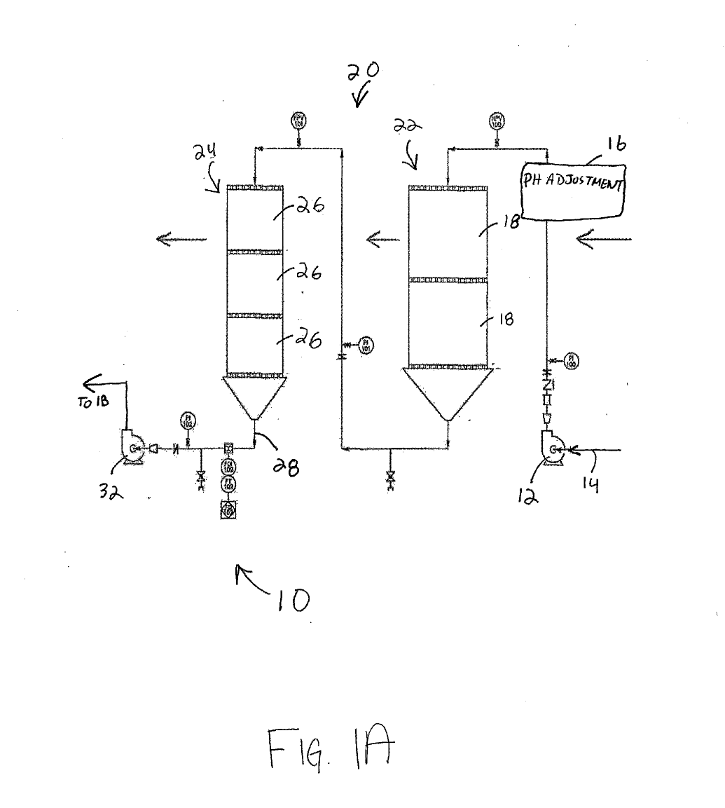

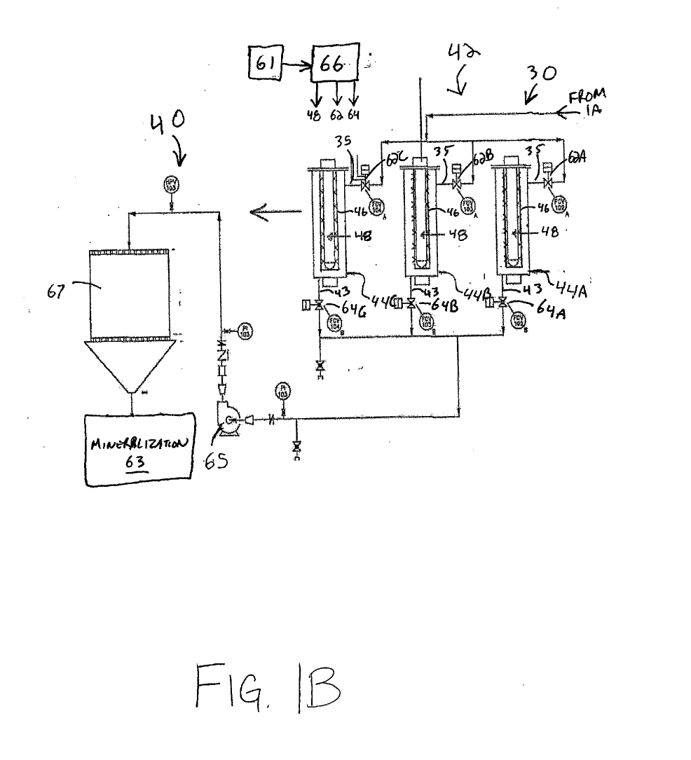

FIGS. 1A and 1B depict an exemplary embodiment of a water purification system 10. The water purification system 10 includes a plurality of sequential chambers filled with various types of water treatment media. As described in further detail herein, the chambers can be constructed of a variety of materials, including, but is not limited to: stainless steel, carbon steel, High Density Polyethylene (HDPE), and Polycarbonate. The chambers may further be lined with corrosion resistant liners.

Ultraviolet (UV) light, particularly UV light in the UVC wavelength band between 100-280 nm, is a known approach to remove some microorganisms and chemicals from water. However, water turbidity, dissolved solids, and other contaminants can limit the effectiveness of UV water treatment. Additionally, available systems are limited in their ability to scale and/or to effectively treat increasingly large volumes of water for increased system flow rates and through-put. A system 10 is provided herein which solves these problems to improve the effectiveness of UV water treatment and the quality of water output from such a system.

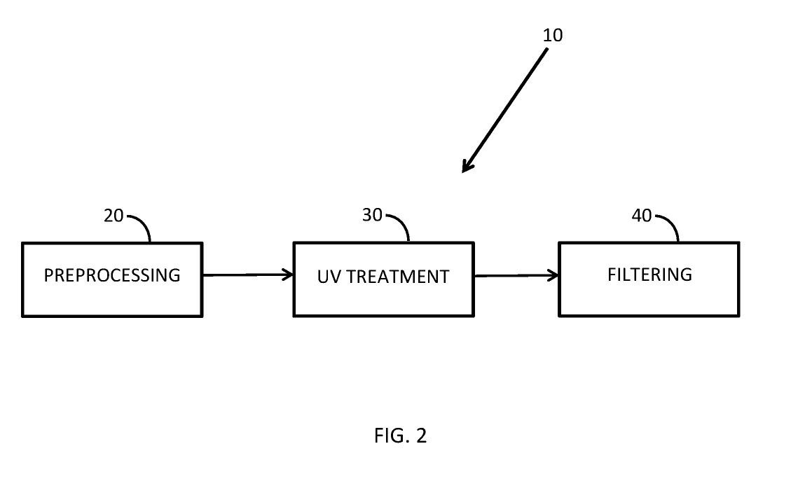

FIG. 2 is a system diagram of an exemplary embodiment of a water purification system 10. The water purification system 10 exemplarily includes three stages, embodiments of which are provided in further detail herein. The water purification system 10 includes a preprocessing stage 20, a UV treatment stage 30, and a filtering stage 40.

The UV treatment stage 30 exposes the water flowing through the system to UVC light in manners to maximally expose any microorganisms and any UV reactive chemicals in the water to UV radiation. The UV treatment stage kills microorganisms in the water by exposing them to the UV radiation which, for example, breaks the molecular bonds within the microorganismal DNA.

The preprocessing stage 20 primarily serves to clarify the water in order to improve effectiveness of the UV treatment stage 30. The preprocessing stage 20 may take many forms as described in further detail herein, but in an exemplary embodiment includes mechanical filtration. In still further exemplary embodiments, different types of filtration using different types of filtering media may be used to target removal of specific substances from the water. In embodiments as described herein, multiple filtering stages may be used in a predetermined order in which earlier filtering systems improve the effectiveness of subsequent filtering stages. In another exemplary embodiment, the preprocessing stage 20 includes pH adjustment of the incoming water to place the water in a pH range suitable for subsequent treatment stages.

The filtering stage 40 receives the water out of the UV treatment stage 30 and removes the by products of the UV treatment. As a result of the UV treatment, biochemicals, peptides, and other organic matter may be dispersed in the water. The filtering stage 40 as described in further detail herein works to remove these substances before the water exits the system in a fully treated form.

The processing stage 20 is constructed of a plurality of chambers. Each chamber is filled with a single filter media or a multi-media blend to remove specific contaminants in an ordered sequence. This ordered sequence of media types maximizes the use of each media type at each stage to produce a system that reduces a broad range of contaminants. The media can include, but is not limited to: Mesh Screens or slotted plates for solids separation, woven or non-woven natural or synthetic fibers, Activated Carbon, Activated Alumina, Anthracite, Banana Peel Fiber, Citrus Peel Fiber, Ceramic, Cellulose, Bentonite, Birm, Filter Sand, Glass Beads, Gravel, Garnet, Impregnated Activated Alumina, Ion Exchange Resins, Manganese Dioxide, Manganese Greensand, Micro Fiber Material, Montmorillonite, Nanofiber Material, Natural Zeolite, Neutralizing Media, Peat, Redox Alloys, and Synthetic Zeolite.

A water feed pump 12 brings contaminated influent water 14 to the processing stage 20 of the water treatment system 10. In exemplary embodiments, the water feed pump 12 may be a centrifugal pump or a centripetal pump. It will be recognized that the pump 12 may be any kind of pump as recognized by a person of ordinary skill in the art.

Optionally, in embodiments, the contaminated influent water media selected to raise or lower the pH of incoming contaminated water. The media and the effect of the pH adjustment chamber (e.g. raise water pH or lower water pH) may be selected at least in part based upon the contaminants in the water and the pH of the incoming water. Highly acidic or highly alkaline water, as may be found in some contaminated water sources, may impair the function of, damage, or degrade the filtering or treatment media in the rest of the preprocessing stage 20. Therefore, a pH adjustment to a relatively neutral pH (e.g. 5.5 to 8.5) may be beneficial as a first treatment in the preprocessing stage 20.

The next chambers of the preprocessing stage 20 are exemplarily mixed media filter chambers 18. The filter chambers 18 may be arranged in a tower 22 so that the water can flow through the chambers 18 by gravity feed. A first chamber 18 is filled with a media through which the water is passed to physically remove an initial level of contaminants and clarify the water. In an embodiment, this may also provide some further pH buffering. In a non-limiting embodiment, the media of the first chamber 18 is a physical filter material including, but not limited to mesh screens, slotted plates, or fibers (natural or synthetic).

The water flows to the next chamber 18 in the tower 22 be a gravity feed. This chamber 18 is filled with a media to further remove contaminants to clarify the water. In an exemplary embodiment, the media of the second chamber 18 is activated charcoal. As described in further detail herein, the chambers may be constructed with a series of internal weirs and baffles that organize the water flow to maximize media contact time and to reduce channeling which further improves the effectiveness of the media. The water flows out of the tower 22 and is directed to further treatment in the preprocessing stage 20.

The second stage of the treatment process is a resin filter tower 24 which includes a plurality of chambers 26 filled with ion exchange resins to adjust the pH and/or remove specific contaminants. In an exemplary embodiment, resin filter tower 24 is provided by three ion exchange chambers 26, although more or fewer may be used in other embodiments. The tower arrangement of the ion exchange chambers 26 enable the water to flow through the resin filter tower 24 by gravity feed.

The water successively flows though the ion exchange chambers 26 of the tower 24 wherein it passes through different ion exchange resins in order to adjust pH and remove specific contaminants. The specific ion exchange resins selected for each of the ion exchange chambers are done so to work in synergistic function with the ion exchange resins and mechanisms before and after each chamber.

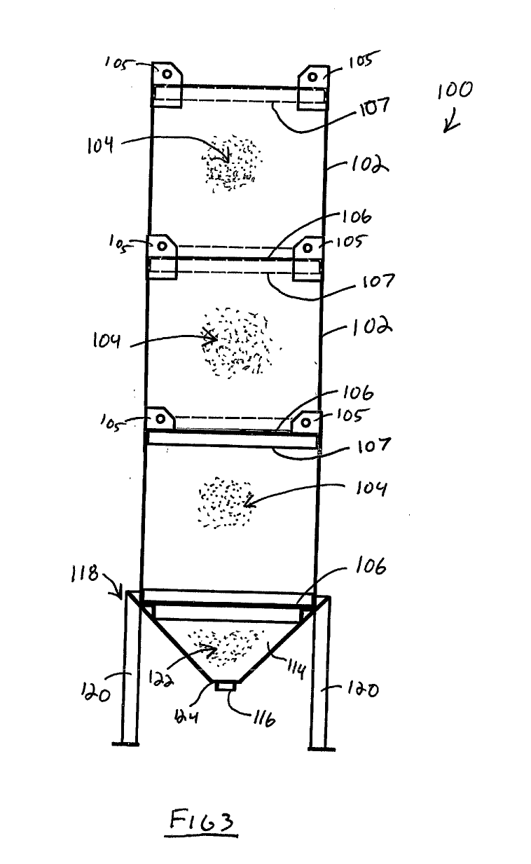

FIG. 3 depicts an exemplary embodiment of a filter tower 100 which is exemplarily constructed of a plurality of chambers 102. The filter tower 100 may exemplarily embody the tower 22 and/or the chamber 18 or the ion exchange tower 24 or ion exchange chambers 26 as depicted and described above in FIG. 1. The chambers 102 are constructed with at least one of vertically extending sidewall, or in many cases a plurality of vertically extending sidewalls. Each chamber 102 is exemplarily constructed as a stainless steel box. The dimensions of the chambers 102 may vary, but two merely exemplary and non-limiting embodiments may be 24″ cubes or 36″ cubes. In an exemplary embodiment, the filter tower 100 includes three chambers 102 stacked vertically upon one another. This exemplarily enables the water being treated to flow by gravity once the water is pumped to the top of the filter tower 100.

As described above, each chamber 102 of the plurality of chambers 102 is filled with a filter media 104. The filter media may exemplarily be an ion exchange resin. In other embodiments, the filter media may be a natural fiber, or other physiological filter media, or exemplarily activated charcoal or any of the other media as described above. In embodiments, using an ion exchange resin, the ion exchange resin may additionally change or adjustment the pH of the water and/or remove specific contaminants from the water, as selected for by the ion exchange resin used.

The chamber 102 further includes a perforated plate 106 that forms the bottom of the chamber 102. The filtering media 104 may exemplarily be held within the chamber 102 by the perforated plate 106, which permits the water being treated to exit the chamber 102 while retaining the filter media 104 within the chamber 102. In an exemplary embodiment, the perforated plate 106 may exemplarily be a plate of stainless steel with a regular pattern of punched holes perforating at least through a portion thereof. In another exemplary embodiment, this may be provided by expanded metal mesh. In still further embodiments, and as disclosed in detail herein, the perforations through the plate may be of predetermined sizes and locations so as to facilitate fluid flow or circulation.

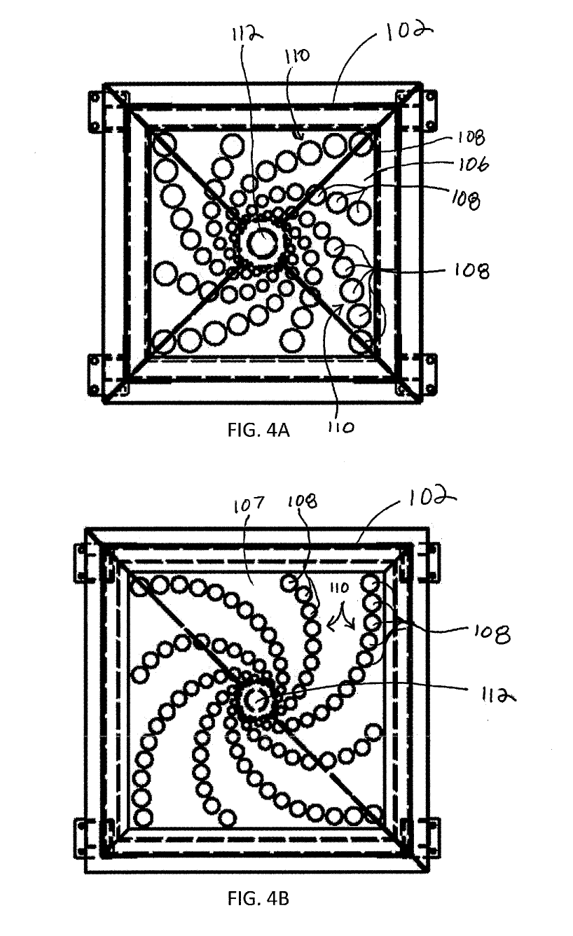

FIGS. 4A and 4B respectively depict two exemplary embodiments of the perforated plate 106. The plates are each provided with a plurality of perforations 108 arranged in a spiral pattern. The perforations 108 are exemplarily arranged in eight arms 110 of progressively decreasing diameter as the arms 110 extend radially inwards towards a center of the perforated plate 106. It will be recognized that other patterns or arrangements of the perforations 108 may be used in other embodiments of the perforated plate 106. However, particular advantages have been observed with the exemplary patterns of perforations as described herein with respect to FIGS. 4A and 4B.

In another description, the diameters of each of the perforations in an arm 16 increase as the spiral pattern of the arm of perforations extends away from the center of the perforated plate 106. It will be recognized that other numbers, arrangements, or configurations of arms 110 may by used in other embodiments. In an exemplary embodiment, the eight arms 110 are arranged with one arm 110 starting at each corner, and one arm 110 starting along each side of the perforated plate 106. In an exemplary embodiment, each arm 110 extends radially inwards towards the center 112 while also extending circumferentially about the center 112, in a spiral pattern. In an exemplary embodiment, each arm 110 extends approximately 180° about the plate 106 between a respective corner or edge of the plate 106 and the center 112. In an exemplary embodiment, a center hole may be located at the center 112 or the center 112 may be perforation free. In a still further exemplary embodiment, the perforations 108 of each of the arms 110 may meet at the center 112 of the plate 106.

In embodiments, the arrangement of perforations 108 into the spiral arms 110 exemplarily creates a swirling flow of water through the chamber 102. This swirling flow of water both increases the exposure of the water to the filter media 14 contained within the chamber 102, but also mitigates and/or prevents channeling in the filter media which can reduce filter media 104 effectiveness over time. The perforated plates 106 can thus help to circulate the water as it travels through the filter tower 100 by a gravity feed of water.

Referring back to FIG. 3, in an exemplary embodiment, chambers 102 may further include a top perforated plate 107 that defines a top of the respective chamber 102. The top perforated plate 107 can help to retain the filter media 104 within a respective chamber 102. The perforated plate 107 can further help to create circumferential flow of water into and through the filter media 104 in addition to the circulative effects of the perforated plate 106. Particularly, this may occur when the top perforated plate 107 includes perforations in an exemplary spiral patter as described above.

In still further embodiments, the perforated plates 106, 107 may be each additionally provided with a screen which may be constructed of metal or non-metal materials. The screen associated with each perforated plate 106, 107 further helps to retain the filter media 104 within a respective chamber 102. The pore size of the screen may be suitably selected to retain the filter material 104 of that chamber 102, while maximizing fluid flow.

In an exemplary embodiment wherein each chamber 102 includes a bottom perforated plate 106 and a top perforated plate 107, when chambers are secured to one another in a filter tower 100, adjacent bottom perforated plates 10 and top perforated plates 107 may be in alignment or out of alignment. If in alignment, this may promote flow between the adjacent chambers 102. If out of alignment, the interface between the adjacent chambers 102 may further create agitation and turbulence in the water being treated as the water is directed through the perforations of adjacent bottom perforated plate 106 and top perforated plate 107. This agitation may be further facilitated by a gap 109 between the adjacent bottom perforated plate 106 and top perforated plate 107.

In a still further embodiment, the bottom perforated plates 106 and the top perforated plates 107 of each chamber 102 are constructed with the perforations 108 extending in opposing clockwise and counterclockwise directions. This is exemplarily depicted in FIG. 4B, which exemplarily depicts a bottom perforated plate 106 with arms 110 of perforations 108 arranged in a counterclockwise spiral, while FIG. 4A exemplarily depicts a top perforated plate 107 with arms 110 of perforation arranged in a clockwise spiral. It will be recognized that the arrangements of FIGS. 4A and 4B may be similarly applicable to either bottom perforated plates 106 or top perforated plates 107.

Exemplarily with this arrangement of a top perforated plate 107 with opposing orientation of the perforations comparted to bottom perforated plate 106, the flow of water enters each chamber 102 and is directed to circulate in a first direction, e.g. clockwise. The bottom perforated plate 106, with perforations in a spiral in an opposing orientation, draws the water out of the chamber 102 circulating in the other direction. This creates turbulent flow within the chamber 102 as the water changes direction of circulation. This turbulent flow within the chamber 102 facilitates treatment of the water by the filter media 104, and also further reduces channeling through the filter media 104 as discussed above.

In still further embodiments, wherein adjacent vertically stacked chambers 102 are arranged with a space between the bottom perforated plate 106 up the upper chamber 102 and the top perforated plate 107 of the lower chamber 102 and the perforations of the respective perforated plates 106, 107 are oriented in opposing directions of spirals, further turbulent flow is created within this space.

Each chamber 102 further includes guide brackets 105 that extend exterior of and upwards from each of the sidewalls of the chamber 102. The guide brackets 105 facilitate a secure, but reversible engagement between stacked adjacent chambers. In an embodiment, the guide brackets 105 are dimensioned to securely engage the exterior of the sidewalls of the stacked adjacent chamber 102 and extend vertically a sufficient length to securely hold the chamber 102 due to the weight of the chamber 102 itself and the weight of the filter media 104 within each chamber. In other exemplary embodiments, the guide brackets 105 may include further positive engagement for example, latches, clasps, retention pins, or other positive engagement features as may be recognized by a person of ordinary skill in the art.

In an exemplary embodiment, the filter tower 100 comprises at least one funnel 112 located below at least one of the perforated plates 106. The funnel 112 may exemplarily by pyramidal funnel that reduces the cross-sectional diameter of the filter tower 100 (e.g. 24″ or 36″) into the diameter of the outlet pipe 116 (e.g. 2″) and directs all of the water flow from the filter tower 100 out of the outlet pipe 116. The funnel 114 may thus be exemplarily located as part of a support frame 118 exemplarily comprising a plurality of legs 120 such as to elevate the filter tower 100. Exemplarily, this also provides clearance for the outlet pipe 116 and room to direct the outlet pipe 116 as described herein.

In exemplary embodiments, a bed 122, of a coarse material to serve as a functional support, is contained within the funnel 114. The bed 122 may include any of a variety of coarse materials, including but not limited to carbon, zeolite, calcium, dolomite, or activated aluminum. The coarseness of the material facilitates fluid flow. The bed 122 further helps to entrain any filter media 104 to pass through the perforations 108 in the plate 106 and also a screen which may be associated with the plate 106, without impeding fluid flow. Embodiments may further include a screen 124 and/or further perforated plate at the transition between the funnel 114 and the outlet pipe 116. The screen 124 exemplarily retains the gravel bed 122 within the funnel 114. In still further exemplary embodiments, the bed 122 may be provided of another material besides gravel, including but not limited to other filter media, as may be recognized by a person of ordinary skill in the art.

In exemplary embodiments, a funnel 114 and bed 122 may be provided in connection with each chamber 102 in the filter tower 100. In such embodiments, this may provide further filtering and treatment during the preprocessing stage 20, but may also help to prevent intermingling of the filter media 104 between the chambers 102, for example in some embodiments. In some embodiments of this, the funnels 114 may be connected to or a part of the associated chamber. In one such embodiment, a funnel 114 from a upper chamber 102 may extend into a portion of a lower chamber 102. The top perforated plate 107 of the lower chamber 102 may be positioned below the outlet of the funnel 114 of the upper chamber 102. In another embodiment, the funnel 114 of the upper chamber 102 may be supported above the lower chamber 102 and the top plate 107 of the lower chamber 102 positioned as previously described and depicted in FIG. 3.

Referring back to FIG. 1, the water exits the ion exchange chambers 26 of the resin filter tower 24 through an outlet pipe 28. A water feed pump 32 moves the water from the outlet pipe 28 from the outlet of the resin filter tower 24 to the UV treatment stage 30 of the water purification system 10. The UV treatment stage 30 is exemplarily embodied in an Ultraviolet (UV) photo reactor system 42. The UV reactor system 42 exemplarily includes a plurality of reactor tanks 44. Each reactor tank 44 includes a hollow quartz crystal sleeve 46 mounted in the middle of the tank 44. Inside each of the reactor tanks 44, within the hollow quartz crystal sleeve 46 is an ultraviolet light source 48 that emits ultraviolet light in the C wavelength (UVC) e.g. within the 100 nm-280 nm wavelength band, which kills germs and breaks down harmful organic and inorganic compounds via photochemical oxidation. The quartz crystal sleeve 46 keeps the internal components of the UVC light source 48 dry while still allowing maximum ultraviolet light permeability through the quartz surface and into the water being treated inside the UV photo reactor tank 44.

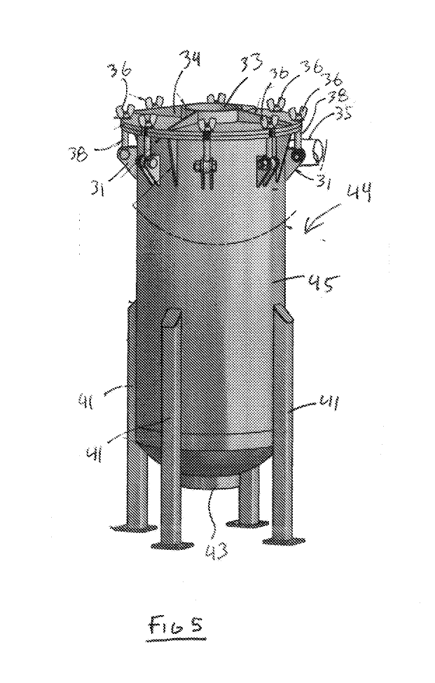

FIG. 5 depicts a perspective view of an exemplary embodiment of a reactor tank 44. The reactor tank 44 includes a reactor tank body 45 which is exemplarily cylindrical and constructed of stainless steel. As may be recognized by a person of ordinary skill in the art, the reactor tank 44 may take on other shapes and/or material constructions. A plurality of legs 41 extend from the reactor tank body 45 and exemplarily support the reactor tank 44 at an elevated position. The reactor tank body 45 exemplarily further includes an outlet 43 at the bottom of the reactor tank body 45 through which the water passes after UV treatment as described in further detail herein.

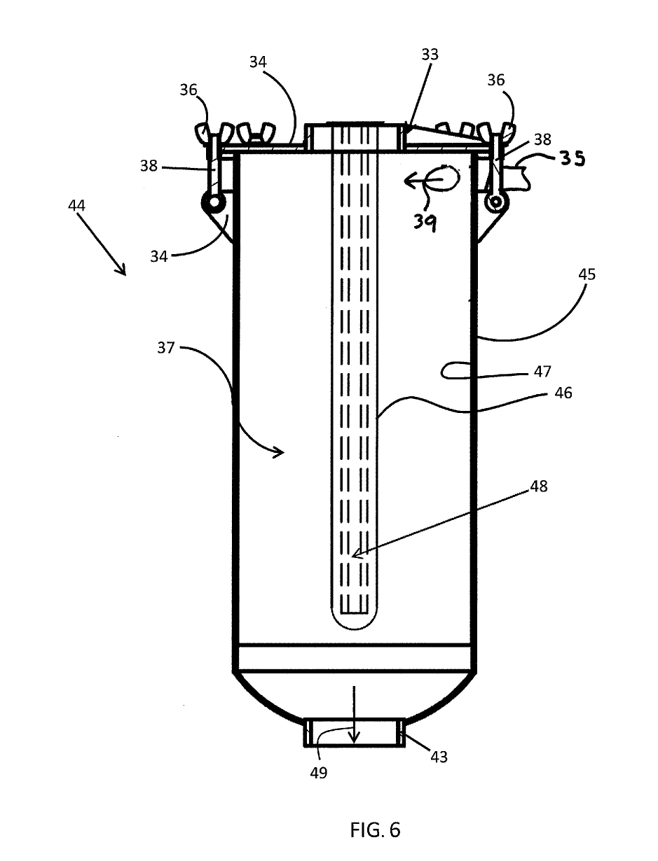

The reactor tank 44 exemplarily comprises a lid 34 that is secured to the reactor tank 44 by a plurality of nuts 36 connected to threaded rods 38. The nuts 36 are exemplarily wing nuts, but may be any other type as recognized by a person of ordinary skill in the art. The threaded rods 38 may be secured to the reactor tank body 45 exemplarily at pivotable lugs 31. The lid 34 includes a top opening 33, which may include a threaded coupling. As described in further detail herein, the UVC light source 48 (FIGS. 1, 6) exemplarily extends into the reactor tank 44 through the opening 33.

An inlet 35 is exemplarily located at the top and side of the reactor tank 44. In an embodiment, the inlet 35 is connected to the reactor tank 44 at the side of the reactor tank body 45. The inlet 35 may be connected tangentially to the cylindrical shape of the reactor tank body 45. In another embodiment, the inlet 35 is connected to the reactor tank 44 through the lid 34. In such an embodiment, the inlet 35 may enter the reactor tank 44 through the lid 34 at an angle, for example a 45° angle. Further, the inlet 35 may be oriented to be located along the side or exterior circumference of the lid 34. In either embodiment, the inlet 35 is orientated and/or positioned to create a circumferential flow of water within the reactor tank 44 as the reactor tank 22 fills with water.

FIG. 6 is a sectional view of an exemplary embodiment of a reactor tank 44 as taken along line 6-6 of FIG. 5. The section view of the reactor tank 44 further depicts an interior 37 of the reactor tank 44. As will be described in further detail herein, the interior 37 and the reactor tank 44 fills with the filtered water 39 through the inlet 35 while not depicted in FIG. 6, the flow path of the treated water 49 out of the reactor tank outlet 43 is occluded by a valve as depicted in FIG. 1. Therefore, the filtered water 39 fills the interior 37 of the reactor tank 44 for UV treatment.

A UVC light source 48, as will be described in further detail herein, extends through the top opening 33 along a central axis of the reactor tank 44. A sleeve 46, exemplarily constructed of quartz crystal provides a barrier between the UVC light source 48 and the water held within the interior 37 of the reactor tank 44. In an embodiment, the top opening 33 includes threads that may facilitate connection of the sleeve 46 and/or the UVC light source 48 to the reactor tank 44. In exemplary embodiments, the quartz crystal sleeve 46 provides a physical barrier between the water and the electronics of the UVC light source 48, but permits transmissions of the UVC light through the sleeve 46 and into the water to treat the water with UVC radiation. The reactor tank body 45 further includes an interior surface 47 which is exemplarily provided with a mirrored surface. In an embodiment, the interior surface 47 may be stainless steel polished to a mirrored or semi-mirrored surface, increasing reflection of UVC light from the UVC light source 48 back into the water contained within the open interior 37 of the reactor tank 44. In another embodiment, a mirrored surface coating may be applied to the interior of the tank, including glass coatings.

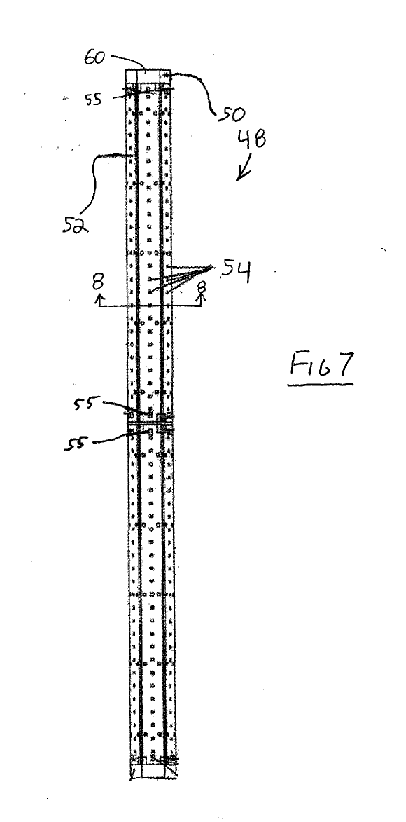

FIG. 7 depicts an exemplary embodiment of the ultraviolet light source 48, which exemplarily includes an array of UVC LEDs arranged for germicidal and photo chemical oxidation effectiveness for water treatment. The UVC light source 48 is exemplarily constructed of a hexagonal aluminum mainframe 50. A plurality of printed circuit boards (PCB) 52 each including a plurality of Ultraviolet Wavelength C (250 nm-280 nm) light emitting diodes (UVC LEDs) 54 and associated LED drivers 55 mounted to the PCBs 52. The mainframe 50, printed circuit board 52, driver 55, diode 54 approach follows that of a computer architecture which is new to the UV treatment process.

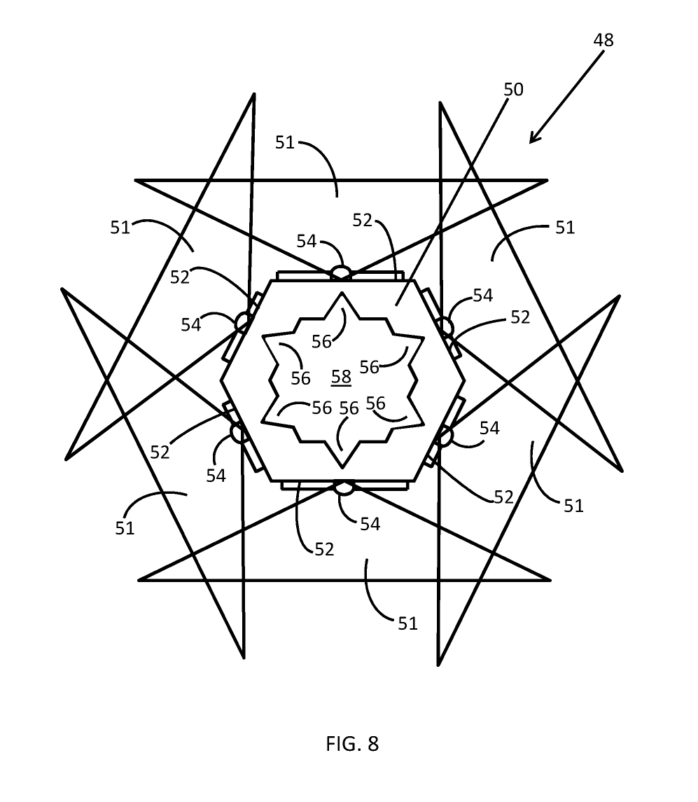

FIG. 8 is a cross sectional view of the ultraviolet light source 48 taken along line 8-8 of FIG. 7. As best seen in FIG. 8, the hexagonal aluminum mainframe 50 includes a plurality of air channels 56 which may be e.g. milled, cast, or extruded into the hexagonal aluminum frame 50 directly behind the back of each UVC LED 54 and/or each LED driver to draw the heat into the center channel 58 of the hexagonal aluminum mainframe 50. While depicted as triangular in cross section, the air channels 56 may be constructed in other cross-sectional shapes, including but not limited to rectangular or rounded shapes. The heated air circulates to dissipate the heat both across the entire surface of the hexagonal aluminum mainframe 50 as well as to direct the heated air out of a top opening 60 (FIG. 7) of the hexagonal aluminum mainframe 50 where it may be directed through air cooling/induction or natural dissipation external of the reactor tank 44 (e.g. FIG. 6).

As depicted in FIG. 8, each of the LEDs 54 produces a cone 51 of UVC wavelength radiation. It will be recognized that since FIG. 8 is an exemplarily horizontal sectional view, that the cones 51 may exemplarily have a similar cross-sectional shape in a vertical sectional view as well. The cones 51 of UVC wavelength radiation are of a beam angle that is exemplarily wide, for example, but not limited to 135°. In further embodiments, the beam angle is greater than 135°. A person of ordinary skill in the art will recognize that other angles may be used. Although in embodiments for reasons as explained in further detail a beam angle of at least 135° may be preferred. However, it will be recognized that with a greater number of sides of the mainframe 50, the bean angle may be reduced while still maintaining UVC radiation about the mainframe 50. The hexagonal shape of the mainframe 50 results in six arrays of LEDs 54 arranged along the sides of the mainframe 50. The wide angle of the cones 51 of the UVC wavelength radiation thus intersect with adjacent cones 51 of UVC wavelength radiation. This is depicted in FIG. 8. Thus, coverage of the area about the entire UVC light source 48 with UVC wavelength radiation is achieved. In a still further embodiment, while the area nearest and directly in front of each LED is irradiated with UVC wavelength irradiation from that adjacent LED 54, at angles and positions further from each LED, radiation from multiple LEDs 54 is received. As noted above, since the cones 51 of UVC wavelength radiation are projected in three dimensions, a similar overlapping effect of adjacent cones 51 of UVC wavelength radiation is achieved from vertically adjacent LEDs 54 in the same array on a single side of the mainframe 50.

Referring back to FIG. 1B, as previously noted, valves 64 are fluidly connected to the outlets 43 of the respective reactor tanks 44. The valves 64 are operated in the manner as described herein to selectively control the flow of treated water out of the respective reactor tanks 44. Microcontroller 66 is exemplarily communicatively connected to at least the valves 62 and 64, as well as the UVC light sources 48. In addition, the controller may be further connected to one or more of the pumps (12, 32, 65) in the system 10 and/or sensors, for example, flow sensors, pressure sensors or volume sensors as may be distributed within the system 10 as recognized by persons of ordinary skill in the art in order to achieve the measurements as described in further detail herein. The controller 66 may exemplarily be a microprocessor that is communicatively connected to a computer readable medium 61 programmed with computer readable code that, when executed by the controller 66, causes the controller 66 to carry out the functions as described in further detail herein. The computer readable medium 61 may exemplarily be integral with the controller 66, or may alternatively be a separate component, although, in either event the computer readable medium 61 is communicatively connected o the controller 66. The computer readable medium may be embodied on any type of computer memory as will be recognized by a person of ordinary skill in the art and may be embodied in software, hardware, or firmware.

The controller 66 operates at least portions of the water purification system 10, and more specifically, portions of the UV treatment stage 30 in order to carry out functions of exemplary embodiments of the water purification system 10 as described herein.

In an embodiment, the controller 66 exemplarily operates the valve 62A to open to a flow of filtered water exiting the preprocessing stage 20, and exemplarily provided by the water feed pump 32. In the embodiment, the valves 62B and 62C are held closed such that the flow of filtered water is only provided to the reactor tank 44A. As the water enters the first UVC LED photoreactor tank 44A, the LEDs 56 in the associated ultraviolet light source 48 are activated. This exemplarily may occur upon opening of the valve 62A, or may be controlled based upon a signal from a flow sensor either located proximal to the valve 62A or located within the reactor tank 44A. The ultraviolet light source 48 provides UVC wavelength radiation into the filtered water flowing into and held within the reactor tank 44A. The UVC radiation is exemplarily projected in the patterns as described above with respect to FIG. 8 and further exemplary reflects off of the polished interior surface of the reactor tank. Additionally, positioning of the inlet 35 to the reactor tank 44A at the side and top of the reactor tank creates a circulating flow effect within the reactor tank as the reactor tank fills. These features combine to increase the exposure of the filtered water to the UVC radiation. When the first UVC LED photo reactor tank 44A is full, as may be exemplarily detected by a volume sensor and/or flow sensor, the controller 66 operates the valve 62A to close and to instead open valve 62B to direct the water into the second reactor tank 44B. The second reactor tank 44B begins to fill in the same manner as described above with respect to the reactor tank 44A. Similar to that of the reactor tank 44A, when the water beings to fill the second reactor tank 44B, the UVC LEDs 56 of the ultraviolet light source 48 associated with the second reactor tank 44B are activated by the controller 66. The ultraviolet light source 48 of the second reactor tank 44B operates in the same manner as described above to irradiate the filtered water provided to the reactor tank 44B through the valve 62B with UVC wavelength radiation. When the second UVC LED photo reactor tank 44B is full, the controller 66 operates the valve 62B to close, preventing further flow of filtered water into the second reactor tank 44B. Upon closing the valve 62B, the controller 66 operates to both open the valve 62C to allow the filtered water to flow into the third reactor tank 44C for UVC radiation treatment. In an exemplary embodiment, simultaneously with the closing of valve 62B and the opening of valve 62C, the outlet valve 64A is opened allowing the (now treated with UVC radiation) water from the reactor tank 44A to exit the UV photo reactor system 42 of the UV treatment stage 30. By maintaining relatively constant input flow rates and output flow rates, for example as may be facilitated by control instructions from controller 66 to one or more of the water feed pump 32 or the outlet pump 65, by the time that the third reactor tank 44C is full of filtered water, the first reactor tank 44A has been completely drained of treated water. When the water begins to fill the third reactor tank 44C, the UVC LEDs 56 of the ultraviolet light source 48 associated with the third reactor tank 44C are activated by the controller 66 to treat the filtered water with UVC wavelength radiation.

In an exemplary embodiment, the system is timed, so that when the third UVC LED photo reactor tank 44C is full, the valve 62C can be closed by the controller 66, while the controller 66 further operates to close the outlet valve 64A and to open valve 62A so that the flow of filtered water from preprocessing stage 20 can be directed once again into the (now empty) first reactor tank 44A for UV treatment. In an exemplary embodiment, this may be carried out in an automated cycle with the flow rates of the system exemplarily controlled by the water pumps 32 and 65 so that the filtered water exemplarily receives the required time and energy of UVC wavelength radiation exposure such as to purify the filtered water. As the controller 66 cycles through filling and draining the tanks and exposing the water within the tanks to the UVC radiation, the water is respectively held by the reactor tanks 44A-C for a predetermined time for effective UV dosage and exposure for purification. While not depicted, internal weirs/baffles/piping may further create vortex flow within the reactor tanks 44A-C in order to maximize controlled water movement, symmetry, organization and exposure of the water to the UVC wavelength radiation within the reactor tanks 44A-C. In an embodiment, a rounded or other shaped bottom to reactor tank (as depicted in FIG. 6) further facilitates circulation as the tank fills and drains.

As previously noted, embodiments of the water purification system 10 as described herein provide improved water treatment through the preprocessing stage 20 provided before the UV treatment stage 30. The removal of many of the contaminants in the water, for example by filtration removes contamination which may limit the transmission of the UVC wavelength radiation through the water or may absorb UVC radiation rather than that radiation being transferred into compounds and/or organisms which breakdown, oxidize, or otherwise degrade to exposure to UVC wavelength radiation.

After the water has been processed through the UV treatment stage 30, the treated water is provided to a filtering stage 40. In an exemplary embodiment, the post-treatment filtering stage 40 is provided by a filtration chamber 64 which operates to capture and/or absorb the final microscopic constituents that were treated/disassembled in the UV process. In am exemplary embodiment, the filtration chamber 67 is provided by a similar arrangement as may have been used in the preprocessing stage 20, for example with one or more chambers 100 as described above with respect to FIGS. 3-4B, and may include some or all of the same components as described herein. In an exemplary embodiment, the filtration chamber 67 may include activated charcoal as the or one of the filter media. A filter media of activated charcoal has been found to be effective filter media for removing the by products of UV treatment from the treated water.

In another example, the filtering stage 40 may include a filter chamber with an ion exchange resin filer media. This may exemplarily be used to remove remaining lithium to form a lithium ion brine. A lithium ion brine may be used in other industrial processes, for example manufacturers of batteries. In other exemplary embodiments, the ion exchange resin may buffer the pH of the treated water prior to completion of treatment.

In an exemplary embodiment, the water from the filtration chamber 67 is provided to a further optional mineralization stage 63. In the mineralization stage. The treated and purified water may be processed to re-mineralize the water for use as drinking water. With or without the mineralization stage 63, the water leaves the water treatment system 10 in a manner that is clean, clear, and revitalized without the use of chemical additives.

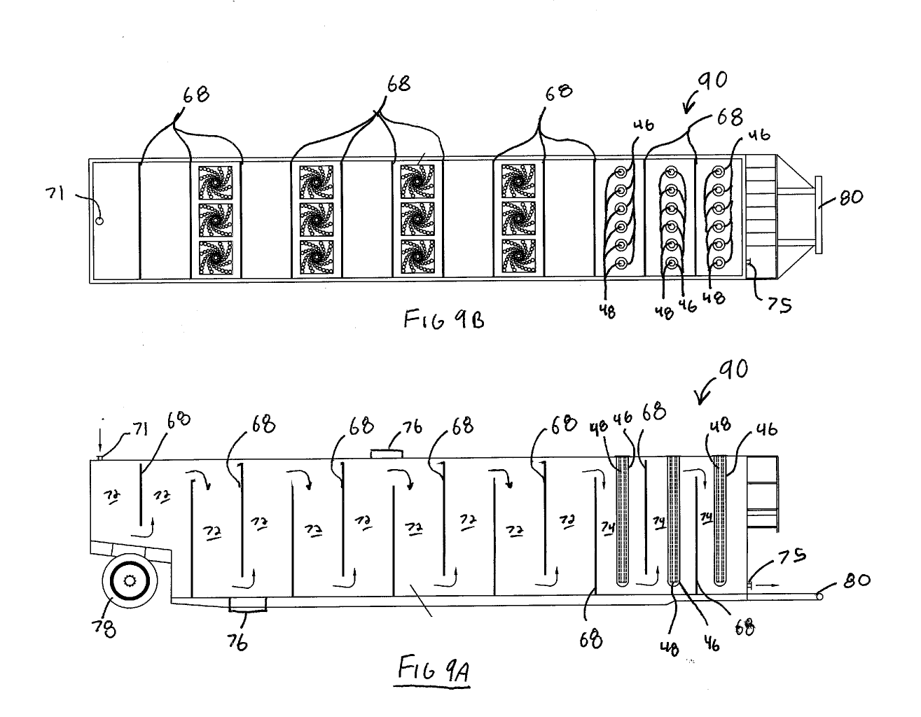

FIGS. 9A and 9B respectively depict side and top views of an additional exemplary embodiment of a water treatment system 90 wherein the structure of system is arranged in a frack style metal box with welded interior weirs/baffles 68 that produce capillary flow over the individual internal media beds 70 in each of the chamber 72 of the system 90. The internal weirs/baffles 68 are designed so the water is directed from an inlet 71 and fills one chamber 72, over or under a set of weirs/baffles 68 into the next chamber 72, travels through the media 70 in that chamber 72 until it fills the chamber 72 and sequentially travels through successive chambers 72 containing media 70. Chamber 74 is a frack tank style weir chamber that has a plurality of UVC LED light sources 48 in quartz crystal sleeve 46 as described inside the interior of the chamber 74 to apply UVC Light (250-280 nm) to the water passing through that chamber 74, in the same manner as described above until the treated water is delivered through outlet 75. It will be recognized that the embodiment of the water treatment system 90 may be rearranged from that depicted such as to exemplarily provide a filtering stage as described above after UVC treatment.

Manways 76 into each chamber 72/74 that allows the media in each weir chamber to be refilled and/or replaced. The lower access manways 76 can be used to maintain internal media and/or remove solids. The tires, 78 and trailer hitch 80 mechanisms of this particular system would apply to all general mobile applications. The system as depicted in can be utilized as a mobile system or as a stationary system plant style system. Not depicted is the system controls panel that synchronizes the systems functions according the input data programmed by the user. The control system is an upward compatible Human Machine Interface (HMI) operating system including, but not limited to, Allan Bradley and Microsoft electronics and operating systems, respectively. Not depicted is the systems control and remote monitoring system that includes, but is not limited to GPS laser satellite, Wi-Fi hardware and software. Supervisory Control and Data Acquisition (SCADA) systems, Programmable Logic Controllers (PLC's), telemetry hardware and software, UV sensors, laser photodiodes, laser photodiode sensors, single parameter probes, multi-parameter probes, digital microscopy, and photo spectroscopy hardware and software.

In an alternate depiction, the water treatment system uses its footprint, structure, and wiring allow for solar panels and wind turbines to be placed on its exterior. Along with inline hydroelectric turbines in the effluent water piping, energy can be produced to feed into the electrical requirements of the system as well as be stored in batteries or energy cells for later use when and if solar or wind energy isn't available.

While not depicted, a still further exemplary embodiment includes the introduction of air bubbles into one or more of the chambers to aid in solid separation, oxidation, and reactivity between media and water being treated.

In a first exemplary embodiment, sewage water contaminated with solids, BOD, TSS, TDS, VOC's, heavy metals, hydrogen sulfide, fecal bacteria, nitrates, nitrites, ammonia, and phosphates. To fully treat the water to a drinkable state, the sewage water is treated with an exemplary embodiment of the water treatment system 10 having a preprocessing stage 20 as described herein, a UV treatment stage 30 as described above, and a filtering stage 40 including an activated carbon filtration. The preprocessing stage 20 includes treatment through filter towers having the following sequential order of filtering media: solids separation and screening, coarse activated carbon, zeolite, activated alumina, fine activated carbon, and ion exchange resins. in one example, an ion exchange resin filter media may be used to remove organic matter prior to the UV treatment stage 30.

In a second exemplary embodiment, mining wastewater contaminated with sulfuric acid or other low pH substance, solids, TSS, heavy metals, phosphates, nitrates, and gross alpha radiation (e.g. from Barium or Radium). To fully treat the water to a drinkable state, the contaminated mining wastewater is treated with an exemplary embodiment of the water treatment system 10 having a preprocessing stage 20 as described herein, a UV treatment stage 30 as described above, and a filtering stage 40 including an activated carbon filtration. The preprocessing stage 20 includes treatment through filter towers having the following sequential order of filtering media: solids separation and screening, pH buffer through lime or limestone, activated carbon filtration, activated alumina filtration, zeolite filtration, and activated carbon filtration. In this example, ion exchange resins may be used for further demineralization, for example to remove heavy metals.

Exemplary embodiments of the system and process as described herein can provide purified water in a chemical free treatment system and process. Embodiments may treat water in a non-stop, flow through process. Still further embodiments may achieve purified water with efficient use of energy. Embodiments of the system as described herein may be configurable and programmable to meet flow and contaminant removal requirements. Embodiments of the system can be operated as stand-alone units or integrated into multiples including, but not limited to parallel pairs, linear multiples, parallel multiples, or into system of networks and sub-networks in order treat large volumes of water in a non-stop flow through process.

Embodiments of the system as disclosed herein may be upward and downward scalable to meet volume requirements for applications including, but not limited from personal portable drinking systems and whole house water treatment systems to municipal drinking and wastewater to industrial wastewater and landfill leachate.

Exemplary embodiments of the system and processes as disclosed herein can also be used to purify/pasteurize/treat beverages such as, but not limited to orange juice and apple juice. Apple juice naturally contains arsenic. The system/process can remove arsenic from apple juice without adding any chemicals or altering the composition of the apple juice whatsoever. The UVC LED system/process can be used as a non-thermal pasteurization process for dairy wherein the UVC light is applied in a sufficient/measured time and UV dosage to reduce the bacteria level to the level of pasteurization. The UV dosage and specific bacteria count/levels can be measured with devices such as, but not limited to, UV meters, UV sensors, Bacteria Counters, Fluoroscopes, and Digital Microscopes. In this application, pasteurization can occur without the use of heat. It has been found that heat in pasteurized dairy products produces harmful bi-products. This approach can reduce/pasteurize the beverage/reduce the proper level of bacteria and potential pathogens without creating harmful bi-products.

Exemplary embodiments of the systems and processes as described herein can neutralize pH. Still further exemplary embodiments can remove and/or reduce contaminants from water including, but not limited to heavy metals, arsenic, volatile organic compounds, polychlorinated biphenyls (PCB's), harmful microorganisms, for example, bacteria, viruses, mold, fungus, yeast, algae, and mosquito larvae, pharmaceutical drugs, pesticides, herbicides, radionuclides, biological oxygen demand (BOD), chemical oxygen demand (COD), an unregulated contaminants.

Exemplary embodiments of the system as described herein can be powered via solar, wind, hydroelectricity, geothermal, rechargeable batteries. In still further embodiments inline hydroelectric turbines within the system can be used to harvest/return energy to the system. Still further embodiments may be communicatively connected to a remote computer monitoring/control system for example through wireless communications systems including but not limited to Wi-Fi and cellular communication platforms.

In the present Description, certain terms have been used for brevity, clearness, and understanding. No unnecessary limitation are to be implied therefrom beyond the requirement of the prior art because such terms are used for descriptive purposes only and are intended to be broadly construed. The different dispenser apparatuses, systems, and methods described herein may be used alone or in combination with other apparatuses, systems, and methods. Various equivalents, alternatives, and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A water treatment system comprising:
a preprocessing stage comprising:
a first chamber being defined by at least one vertically oriented sidewall and a bottom defined by a perforated plate;
a first filter media contained within the first chamber by the at least one vertically oriented sidewall and the perforated plate of the first chamber;
a second chamber being defined by at least one vertically oriented sidewall and a bottom defined by a perforated plate;
a second filter media contained within the second chamber by the at least one vertically oriented sidewall and the perforated plate of the second chamber; and
a first funnel configured to receive water from the first chamber and direct the water to an outlet;
wherein the first chamber, second chamber, first funnel are vertically arranged in a filter tower wherein water travels through the filter tower by gravity feed sequentially through the second chamber, the first chamber, and the first funnel;
a ultraviolet treatment stage that receives water from the first funnel and comprises:
a plurality of reactor tanks that each comprise a valve-controlled inlet and a valve-controlled outlet, each reactor tank of the plurality further comprising a crystal sleeve disposed centrally to the interior of the reactor tank and containing within the crystal sleeve, a UVC light source comprising a plurality of UVC wavelength emitting light emitting diodes (LEDs); and
a controller operably connected to each of the valve-controlled inlets, valve-controlled outlets, and UVC light sources;
wherein the controller operates the ultraviolet treatment stage to sequentially fill each reactor tank and sequentially drain each reactor tank and operate a respective UVC light source to emit UVC wavelength radiation within a respective reactor tank while water is in the respective reactor tank; and
a filtering stage that receives water from the ultraviolet treatment stage and comprises a filtering chamber comprising a third filter media.

2. The system of claim 1, wherein the first filter media is an ion exchange resin filter and the second filter media is a physical filter.

3. The system of claim 1, wherein the preprocessing stage further comprises a pH adjustment of the water prior to receiving the water in the second chamber.

4. The system of claim 1, wherein the third filter media comprises activated charcoal.

5. The system of claim 1, wherein the filtering stage further comprises a mineralization stage that receives the water after treatment in the filtering chamber, wherein the mineralization stage adds minerals back into the treated water.

6. The system of claim 1, wherein the mainframe comprises six sides in a hexagonal arrangement and at least one array of UVC LEDs is secured to each side of the mainframe and the UVC LED's each produce a cone of light having a beam angle of at least 135 degrees.

7. The system of claim 1, wherein the controller operates the valve-controlled inlets and valve-controlled outlets to maintain a continuous flow of water into and out of the ultraviolet treatment stage.

8. A ultraviolet water treatment system comprising:
a water inlet that receives a flow of water;
a first reactor tank comprising an inlet with a first inlet valve and an outlet with a first outlet valve, the first reactor tank comprising a crystal sleeve disposed through the center of the first reactor tank, and a first UVC light source located within the crystal sleeve, the first UVC light source comprising a plurality of UVC wavelength emitting light emitting diodes (LEDs); and
a controller communicatively connected to the first inlet valve, the first outlet valve, and the first UVC light source to selectively fill and drain the first reactor tank from the flow of water at the water inlet and the controller selectively operates the first UVC light source to emit UVC wavelength radiation when water is inside the first reactor tank.

9. The system of claim 8, further comprising:
a second reactor tank comprising an inlet with a second inlet valve and an outlet with a second outlet valve, the second reactor tank comprising a crystal sleeve disposed through the center of the second reactor tank and a second UVC light source located within the crystal sleeve, the second UVC light source comprising a plurality of UVC wavelength emitting light emitting diodes (LEDs); and
a third reactor tank comprising an inlet with a third inlet valve and an outlet with a third outlet valve, the second reactor tank comprising a crystal sleeve disposed through the center of the second reactor tank and a third UVC light source located within the crystal sleeve, the third UVC light source comprising a plurality of UVC wavelength emitting light emitting diodes (LEDs);
wherein the controller operates the first, second, and third inlet valves to sequentially fill the first, second, and third reactor tanks with water and to sequentially turn on the first, second, and third UVC light sources when water enters the respective reactor tanks, and the controller operates the first, second, and third outlet valves to sequentially drain the first, second, and third reactor tanks, and to turn off a respective UVC light source after a respective reactor tank has drained.

10. The system of claim 8, wherein the inlet of the first reactor tank is arranged to create a circumferential flow about the interior of the first reactor tank as the first reactor tank is filled with water.

11. The system of claim 8, wherein an interior surface of the first reactor tank is polished.

12. The system of claim 8, wherein the mainframe comprises six sides in a hexagonal arrangement and at least one array of UVC LEDs are secured to each side of the mainframe and the UVC LED's each produce a cone of light having a beam angle of at least 135 degrees.

13. The system of claim 12, wherein the mainframe is constructed of aluminum and comprises a heat dissipation channel in each side to direct heat from the array of UVC LEDS into a hollow central chamber of the mainframe.

14. A water filtration system comprising:
a first chamber extending in a vertical direction and defined by at least one sidewall and a bottom defined by a perforated plate;
a first filter media contained within the first chamber by the at least one vertically oriented sidewall and the perforated plate of the first chamber;
a first funnel configured to receive water from the first chamber and direct the water to an outlet, the first funnel comprising a screen located across the outlet; and
a first funnel filter media contained within the funnel and retained within the funnel by the screen located across the outlet.

15. The system of claim 14, wherein the perforated plate comprises perforations arranged in a plurality of arms extending outwards from a center of the perforated plate.

16. The system of claim 15, wherein the arms are arranged in a spiral shape.

17. The system of claim 16, wherein diameters of the perforations increase as the perforations are radially further from the center of the perforated plate.

18. The system of claim 14, wherein the first chamber comprises a plurality of support brackets at the top of the at least one sidewall and further comprising:
a second chamber extending in a vertical direction and defined by at least one sidewall and a bottom defined by a perforated plate, a second filter media contained within the second chamber by the at least one vertically oriented sidewall and the perforated plate of the second chamber;
wherein the second chamber is secured to the first chamber by at least engagement with the plurality of support brackets wherein water flows through the second chamber and then the first chamber by a gravity feed.

19. The system of claim 18, further comprising a stand, and the first chamber is secured to and supported by the stand at a position elevated above at least a portion of the stand.

20. The system of claim 18, further comprising:
a second funnel configured to receive water from the second chamber and direct the water to the first chamber, the second funnel comprising a screen; and
a second funnel filter media contained within the second funnel and retained within the second funnel by the perforated plate; and
wherein at least one of the first filter media and the second filter media is gravel.
